(19) United States
(12) Patent Application Publication
(10) Pub. No.: US 2014/0092145 A1
(43) Pub. Date: Apr. 3, 2014

(54) DISPLAY DEVICE AND DRIVING METHOD THEREOF

(71) Applicant: SAMSUNG DISPLAY CO., LTD., Yongin-City (KR)

(72) Inventors: Po-Yun PARK, Seoul (KR); Hyun Seok KO, Yongin-si (KR); Min Joo LEE, Seoul (KR); Yong-Jun CHOI, Asan-si (KR)

(73) Assignee: SAMSUNG DISPLAY CO., LTD., Yongin-City (KR)

(21) Appl. No.: 13/750,788

(22) Filed: Jan. 25, 2013

(30) Foreign Application Priority Data
Oct. 2, 2012 (KR) 10-2012-0109718

(51) Int. Cl. G09G 5/00

(52) U.S. Cl. CPC G09G 5/00
USPC 345/690; 345/214

(57) ABSTRACT

A driving method of a display device is provided. The display device comprises a display panel having a plurality of pixels, a signal controller for controlling operation of the display panel, and a memory connected to the signal controller. The driving method comprises receiving an input image signal for a motion picture or a stationary image, and if the input image signal for the stationary image is received, determining whether the stationary image includes at least one weak pattern, setting a first frequency as a driving frequency to display the stationary image if the stationary image does not include a weak pattern, and setting a second frequency that is higher than the first frequency as the driving frequency if the stationary image includes the at least one weak pattern.

### CROSS-REFERENCE TO RELATED APPLICATION

This application claims priority under 35 U.S.C. §119 to Korean Patent Application No. 10-2012-0109718, filed in the Korean Intellectual Property Office on Oct. 2, 2012, the entire contents of which are incorporated herein by reference.

### BACKGROUND

(a) Field of the Invention

The present invention relates to a display device that reduces power consumption and display defects, and a driving method for driving the display device.

(b) Description of the Related Art

Display devices are extensively used in computer monitors, televisions, mobile phones, and other electronic devices. Examples of display devices include cathode ray tube display, liquid crystal display, plasma display, and other types of display technologies.

A display device may include a graphic processing unit (GPU), a display panel for displaying an image, a driver, and a signal controller.

The graphic processing unit transfers to the signal controller an input image signal corresponding to an image to be displayed on the display panel. The signal controller generates a control signal, and transfers the control signal and input image signal to the driver, which drives the display panel.

The image displayed by the display panel may be classified as a stationary image or a motion picture. The display panel may display images comprising one or more frames per second. If the image signals of consecutive adjacent frames are the same, the display panel may display a stationary image. If the image signals of consecutive adjacent frames are different, the display panel may display a motion picture. In order to display a stationary image or a motion picture, the signal controller first receives an input image signal for each frame from the graphic processing unit. When a stationary image is displayed, the same input image signals are received for every frame, which can lead to an increase in the power consumption of the display device.

### SUMMARY

The present invention is directed to solve at least the power consumption problem in the prior art.

An embodiment of the present invention provides a driving method of a display device, the display device comprising a display panel having a plurality of pixels, a signal controller for controlling operation of the display panel, and a memory connected to the signal controller, the method comprising receiving an input image signal for a motion picture or a stationary image, and if the input image signal for the stationary image is received, determining whether the stationary image includes at least one weak pattern, setting a first frequency as a driving frequency to display the stationary image if the stationary image does not include a weak pattern, and setting a second frequency that is higher than the first frequency as the driving frequency if the stationary image includes the at least one weak pattern.

According to some embodiments of the invention, the memory may store information on the at least one weak pattern. The information on the at least one weak pattern may include information on a frequency corresponding to the at least one weak pattern, and the frequency corresponding to the at least one weak pattern may be higher than the first frequency.

According to some embodiments of the invention, the at least one weak pattern may include a first weak pattern and a second weak pattern that is different from the first weak pattern. In some embodiments, determining whether the stationary image includes at least one weak pattern may include determining whether the stationary image includes the first weak pattern and the second weak pattern, and after determining the stationary image includes the first weak pattern and the second weak pattern, selecting either a frequency corresponding to the first weak pattern or a frequency corresponding to the second weak pattern as the second frequency.

According to some embodiments of the invention, the at least one weak pattern may depend on an inversion driving mode of the display panel.

According to some embodiments of the invention, the information on the at least one weak pattern may include gray information of the plurality of pixels, the gray information may include a first gray and a second gray that is different from the first gray, and the information on the at least one weak pattern may include information on a gray difference between the first gray and the second gray. In some embodiments, the information on the at least one weak pattern may include information on a size of the weak pattern.

According to some embodiments of the invention, the driving method may include setting a third frequency that is higher than the first frequency as the driving frequency, and the second frequency is equal to or less than the third frequency.

Another embodiment of the present invention provides a display device comprising a display panel having a plurality of pixels for displaying an image at a driving frequency, a signal controller configured to receive an input image signal for a motion picture or a stationary image, determine whether the stationary image includes at least one weak pattern if the input image signal for the stationary image is received, and control operation of the display panel, and a memory connected to the signal controller and configured to store information on the at least one weak pattern, wherein the display panel is configured to display the stationary image by setting a first frequency as the driving frequency if the stationary image does not include a weak pattern, and display the stationary image by setting a second frequency that is higher than the first frequency as the driving frequency if the stationary image includes the at least one weak pattern.

According to some embodiments of the invention, the signal controller may include a pattern recognition portion configured to determine whether the stationary image includes the at least one weak pattern based on the input image signal, and a frequency selection portion configured to determine the driving frequency based on a determination result received from the pattern recognition portion.

According to some embodiments of the invention, the information on the at least one weak pattern may include information on a frequency corresponding to the at least one weak pattern, and the frequency corresponding to the at least one weak pattern may be higher than the first frequency.

According to some embodiments of the invention, the at least one weak pattern may include a first weak pattern and a second weak pattern that is different from the first weak pattern, and the pattern recognition portion may include a first pattern recognition portion configured to determine whether the stationary image includes the first weak pattern and a second pattern recognition portion configured to determine whether the stationary image includes the second weak pattern. After the first pattern recognition portion has determined that the stationary image includes the first weak pattern and the second pattern recognition portion has determined that the stationary image includes the second weak pattern, the frequency selection portion may select either a frequency corresponding to the first weak pattern or a frequency corresponding to the second weak pattern as the second frequency.

According to some embodiments of the invention, the weak pattern may depend on an inversion driving mode of the display panel.

According to some embodiments of the invention, the information on the weak pattern may include gray information of the plurality of pixels, the gray information may include a first gray and a second gray that is different from the first gray, and the information on the at least one weak pattern may include information on a gray difference between the first gray and the second gray. In some embodiments, the information on the weak pattern may include information on a size of the weak pattern.

According to some embodiments of the invention, the motion picture may be displayed by setting a third frequency that is higher than the first frequency as the driving frequency, and the second frequency may be equal to or less than the third frequency.

Based on at least the above embodiments of the present invention, power consumption of a display device may be reduced and image quality may be improved.

### BRIEF DESCRIPTION OF THE DRAWINGS

FIG. 1 is a block diagram of a display device according to an embodiment of the present invention.

FIG. 2 is a block diagram of the signal controller of FIG. 1 according to another embodiment of the present invention.

FIG. 3 illustrates an example of a stationary image displayed by the display device of FIG. 1.

FIGS. 4A, 4B, 4C, and 4D are examples of timing diagrams of a driving signal in the display device of FIG. 1.

FIGS. 5, 6, 7, and 8 illustrate examples of stationary image weak patterns displayed by the display device of FIG. 1.

### DETAILED DESCRIPTION

The present invention will be described more fully hereinafter with reference to the accompanying drawings, in which exemplary embodiments of the invention are shown. As those skilled in the art would realize, the described embodiments may be modified in various different ways without departing from the spirit or scope of the present invention.

Hereinafter, a display device and a driving method thereof according to embodiments of the present invention will be described in detail with reference to the accompanying drawings.

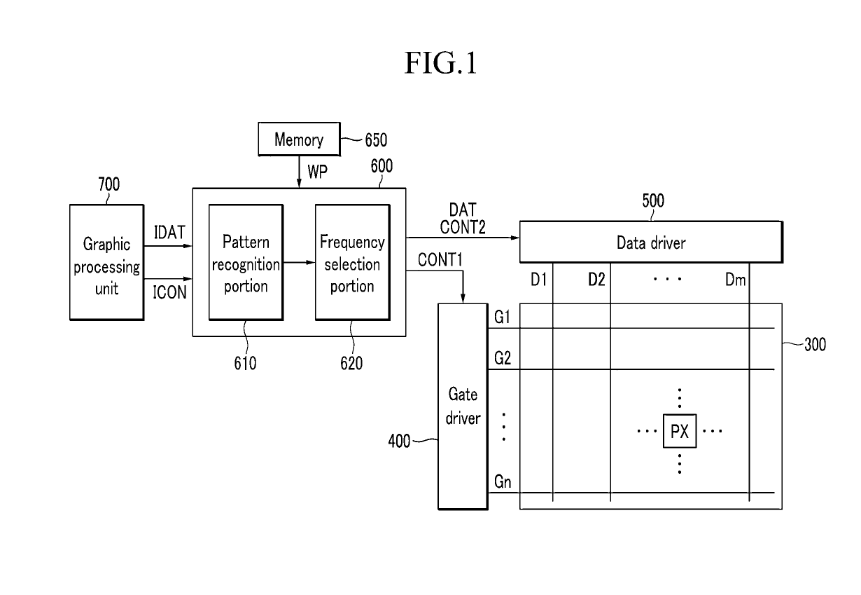

FIG. 1 is a block diagram of a display device according to an embodiment of the present invention.

Referring to FIG. 1, the display device includes a display panel 300, a gate driver 400, a data driver 500, a signal controller 600 for controlling the data driver 500 and the gate driver 400, a memory 650, and a graphic processing unit 700.

The display panel 300 may comprise flat panel displays (FPD) including liquid crystal displays (LCD), organic light emitting displays (OLED), and electrowetting displays (EWD).

The display panel 300 includes a plurality of gate lines G1-Gn, a plurality of data lines D1-Dm, and a plurality of pixels PX connected to the plurality of gate lines G1-Gn and data lines D1-Dm.

The gate lines G1-Gn are configured to transfer gate signals, and extend almost parallel in an approximately row direction. The data lines D1-Dm are configured to apply data voltages, and extend almost parallel in an approximately column direction.

The plurality of pixels PX may be arranged in an approximately matrix form. Each pixel PX may include at least one switching element connected to a corresponding gate line and a corresponding data line, and at least one pixel electrode connected thereto. The switching element may include at least one thin film transistor, and may be turned-on or turned-off according to the gate signal transferred by the corresponding gate line. In addition, the switching element allows a data voltage to be selectively applied from the corresponding data line to the pixel electrode. Each pixel PX may display an image of the corresponding luminance according to the data voltage applied to the pixel electrode.

A desired color may be recognized using spatial and temporal sum of primary colors. Primary colors may include red, green, and blue. To implement a color display, any one of the primary colors may be displayed by each pixel PX based on spatial division, or alternately displayed based on temporal division. A plurality of adjacent pixels PX displaying different primary colors may collectively form a set (referred to as a ‘dot’). In some embodiments, a dot may display a white image.

The gate driver 400 receives a gate control signal CONT1 from the signal controller 600 for generating a gate signal. The gate control signal CONT1 includes a scanning start signal STV indicating the start of scanning, a gate clock signal CPV controlling an output time of a gate-on voltage Von, and at least one low voltage. The gate signal is generated by the gate-on voltage Von which turns on the switching element of a pixel PX and a gate-off voltage Voff which turns off the switching element of the pixel PX. By connecting the gate driver 400 to the gate lines G1-Gn of the display panel 300, the gate signal may be applied to any of the gate lines G1-Gn.

The data driver 500 receives a data control signal CONT2 and image data DAT from the signal controller 600, and selects a data voltage corresponding to the image data DAT. By selecting the corresponding data voltage, the image data DAT may be converted from an analog data signal into an electrical data signal. The data control signal CONT2 includes a horizontal synchronizing signal Hsync indicating the start of transfer of the image data DAT to the pixel PX for a particular row. The data control signal CONT2 also includes a load signal for applying the data voltage to the data lines D1-Dm. The data control signal CONT2 may further include an inversion signal for inverting the polarity of the data voltage to the common voltage Vcom. By connecting the data driver 500 to the data lines D1-Dm of the display panel 300, the data voltage can be applied to any of the data lines D1-Dm.

The graphic processing unit 700 transfers an input image signal IDAT and an input control signal ICON to the signal controller 600.

During a motion picture section, the graphic processing unit 700 may transfer the input image signal IDAT of each frame to the signal controller 600. Conversely, during a stationary image section, the graphic processing unit 700 may not be required to transfer an input image signal IDAT to the signal controller 600 if a same previous input image signal IDAT has been stored in memory 650. For example, if the signal controller 600 is configured to retrieve and process the same previous input image signal IDAT stored in the memory 650, the graphic processing unit 700 may be deactivated during the stationary image section, thereby reducing power consumption. With reference to the above, the stationary image section generally refers to a section in which at least one frame of the stationary image is displayed, and the motion picture section generally refers to a section in which at least one frame of the motion picture is displayed. A stationary image may comprise the same images in consecutive frames, and a motion picture may comprise different images in consecutive frames. The stationary image may also be determined by a predefined areal ratio over an entire screen which is the same for consecutive frames.

The graphic processing unit 700 may transfer the input image signal IDAT of a motion picture to the signal controller 600. The graphic processing unit 700 may also transfer a stationary image start signal to the signal controller 600 at a first conversion time, which corresponds to a time at which the input image signal IDAT of the stationary image is transferred. The graphic processing unit 700 may also transfer a stationary image finish signal to the signal controller 600 at a second conversion time, which corresponds to a time at which the motion picture section starts. When the motion picture section starts, the graphic processing unit 700 provides the input image signal IDAT of each frame to the signal controller 600.

The signal controller 600 receives the input image signal IDAT and an input control signal ICON from the graphic processing unit 700. The input image signal IDAT may contain information on the luminance of each pixel PX, with the luminance having a predetermined number of grays. Examples of the input control signal ICON include a vertical synchronization signal VSync, a horizontal synchronization signal HSync, a data clock signal, or a data enable signal.

The input control signal ICON may include a stationary image start signal indicating the start of display of a stationary image, and a stationary image finish signal indicating the end of display of the stationary image.

The signal controller 600 processes the input image signal IDAT based on the input control signal ICON, and converts the input image signal IDAT into the image data DAT. The signal controller 600 generates the gate control signal CONT1 and data control signal CONT2, based on the input image signal IDAT and input control signal ICON. The signal controller 600 then transfers the gate control signal CONT1 to the gate driver 400, and the data control signal CONT2 and image data DAT to the data driver 500.

When a stationary image start signal is sent from the graphic processing unit 700 to the signal controller 600, the stationary image section starts. The signal controller 600 may then store in memory 650 the input image signal IDAT of the frame corresponding to the start of the stationary image section. The memory 650 may be, for example, a frame memory. During the stationary image section, the signal controller 600 may retrieve and process the input image signal IDAT stored in the memory 650, and transfer the processed input image signal IDAT to the display panel 300. In some embodiments, the signal controller 600 may deactivate the graphic processing unit 700 during the stationary image section, which prevents the graphic processing unit 700 from transferring the input image signal IDAT to the signal controller 600 until the display of stationary image has ended. When the graphic processing unit 700 is deactivated, power consumption of the display device may be reduced.

In some other embodiments, the memory 650 is not used by the signal controller 600 in a motion picture section.

In some embodiments, the memory 650 stores information on at least one weak pattern (referred to as “weak pattern information”—WP). The weak pattern may be associated with a stationary image. In displaying a stationary image driven by a driving frequency, a weak pattern may be defined by a pattern in which image quality defects such as flickers and vertical line stains are present. The driving frequency may refer to a frequency at which an image of a frame is displayed. The driving frequency may also be defined as the frequency at which the gate lines G1-Gn of the display panel 300 are scanned to apply gate signals to the pixels PX.

In some embodiments, the weak pattern information WP may include information on another weak pattern according to a driving mode of the display panel 300, for example, a polar inversion driving mode.

In some embodiments, the weak pattern information WP may include gray information for each pixel PX. Also, a color may include gray information for each pixel PX, or a block of pixels PX. Gray information of the weak pattern information WP may include information on a white gray and a black gray. The white gray and black gray may refer to the highest gray and lowest gray, respectively, as well as different grays of a middle gray. The white gray may also represent a gray that is at the same or higher level than the black gray. The weak pattern information WP may further include information on a gray difference (Δg) between the white gray and the black gray of the weak pattern.

The weak pattern information WP may also include information on a size of another corresponding weak pattern. For example, the size of a weak pattern may be represented by an actual size of another corresponding weak pattern, or as a ratio of an occupying region of the corresponding weak pattern over the entire region of the display panel 300.

The weak pattern information WP may further include information on the frequency corresponding to each weak pattern. The frequencies corresponding to different weak patterns may be the same or different from the other.

In some embodiments, memory for storing the weak pattern information WP and memory for storing the input image signal IDAT to the stationary image may be separately provided in the memory 650 or another memory module.

Referring to FIG. 1, the signal controller 600 includes a pattern recognition portion 610 and a frequency selection portion 620.

In displaying a stationary image, the pattern recognition portion 610 first determines whether the stationary image includes a weak pattern, based on the input image signal IDAT and the weak pattern information WP provided from the memory 650.

A stationary image may have the same pattern form as a weak pattern of the weak pattern information WP; however, if the actual gray difference (Δg_{A}) between the white gray and the black gray of the stationary image is less than a predetermined gray difference (Δg_{P}) of the weak pattern information WP, the pattern recognition portion 610 may determine that the stationary image does not include the weak pattern. Conversely, if the actual gray difference (Δg_{A}) between the white gray and the black gray of the stationary image is greater than the predetermined gray difference (Δg_{P}) of the weak pattern information WP, the pattern recognition portion 610 may determine that the stationary image does not include the weak pattern of the weak pattern information WP.

When the stationary image includes a weak pattern having a size smaller than that of the weak pattern of the weak pattern information WP, the pattern recognition portion 610 may determine that the stationary image does not include the weak pattern of the weak pattern information WP.

When the stationary image includes at least one weak pattern of the weak pattern information WP, the pattern recognition portion 610 may determine that the stationary image constitutes a stationary image(s) of the weak pattern(s) of the weak pattern information WP. Conversely, when the stationary image does not include any weak pattern of the weak pattern information WP, the pattern recognition portion 610 may determine that the stationary image constitutes a stationary image of a general pattern.

The aforementioned determination results may be transferred from the pattern recognition portion 610 to the frequency selection portion 620. The determination results may further include information on the frequency corresponding to the weak pattern included in the stationary image.

The frequency selection portion 620 may determine the driving frequency of the display panel 300 based on the determination results from the pattern recognition portion 610.

For an image of a frame in a motion picture, the frequency selection portion 620 may select a first frequency as the driving frequency. For a stationary image of a general pattern, the frequency selection portion 620 may select a second frequency as the driving frequency. For a stationary image that includes a weak pattern, the frequency selection portion 620 may select, based on the weak pattern information WP from the memory 650, a third frequency corresponding to the frequency of the weak pattern as the driving frequency.

The signal controller 600 may then generate the gate control signal CONT1 and data control signal CONT2 based on the driving frequency selected in the frequency selection portion 620, and transfer the gate control signal CONT1 to the gate driver 400 and the data control signal CONT2 to the data driver 500.

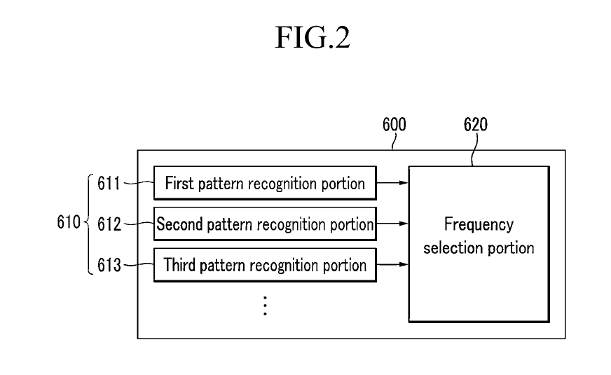

FIG. 2 is a block diagram of the signal controller 600 of FIG. 1 according to another embodiment of the present invention.

Referring to FIG. 2, when the memory 650 stores information on a plurality of weak patterns, the pattern recognition portion 610 may include a plurality of pattern recognition portions for recognizing the plurality of weak patterns.

For example, when the memory 650 includes a first weak pattern, a second weak pattern, a third weak pattern, and so forth, the pattern recognition portion 610 may include a first pattern recognition portion 611 for determining whether a stationary image includes the first weak pattern, a second pattern recognition portion 612 for determining whether the stationary image includes the second weak pattern, a third pattern recognition portion 613 for determining whether the stationary image includes the third weak pattern, and so forth.

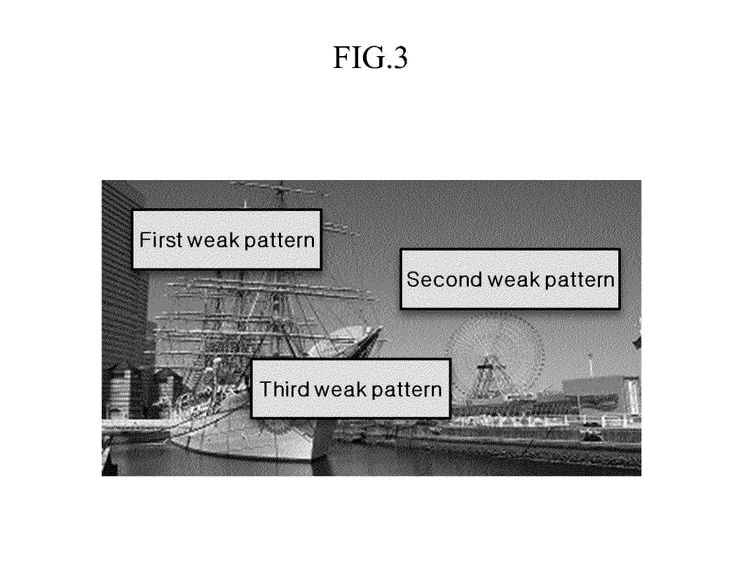

The pattern recognition portions (for example, 611, 612, and 613) for each respective weak pattern determine whether the stationary image includes each weak pattern, based on the input image signal IDAT. For example, in the example shown in FIG. 3, the stationary image includes a first weak pattern, a second weak pattern, and a third weak pattern corresponding to different weak patterns stored in the memory 650. Based on the weak patterns stored in the memory 650, the first pattern recognition portion 611 may determine that the stationary image includes the first weak pattern, the second pattern recognition portion 612 may determine that the stationary image includes the second weak pattern, and the third pattern recognition portion 613 may determine that the stationary image includes the third weak pattern. Subsequently, the pattern recognition portions 611, 612, and 613 may transfer the above determination results to the frequency selection portion 620. The determination results may further include frequency information corresponding to each weak pattern.

In some embodiments, if the frequency selection portion 620 does not receive any frequency information from the pattern recognition portion 610, the frequency selection portion 620 may use frequency information of the weak pattern information WP stored in the memory 650.

In some embodiments, if the stationary image includes a plurality of weak patterns, the frequency selection portion 620 may select a frequency from a plurality of frequencies corresponding to the plurality of weak patterns as the driving frequency. In some embodiments, the frequency selection portion 620 may select the highest frequency among the plurality of frequencies. By selecting the highest frequency, image quality defects in the plurality of weak patterns may be reduced.

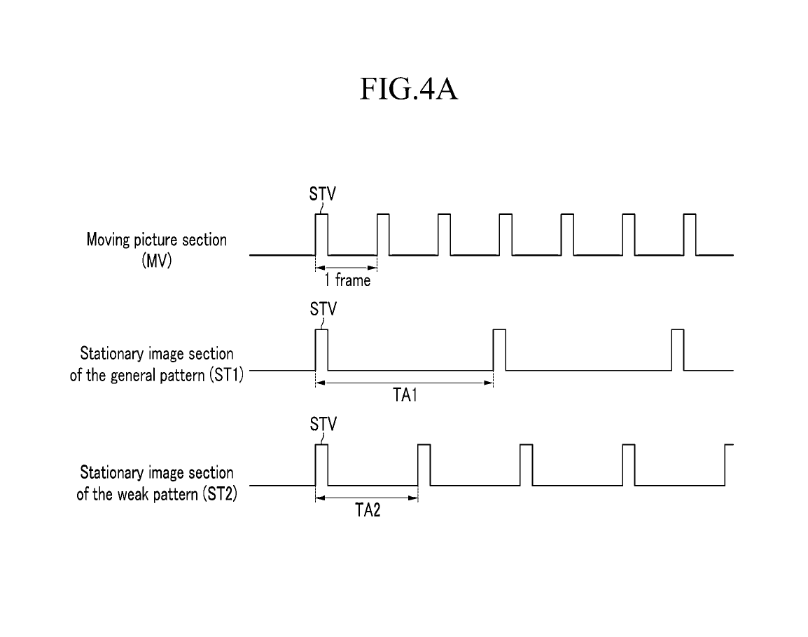

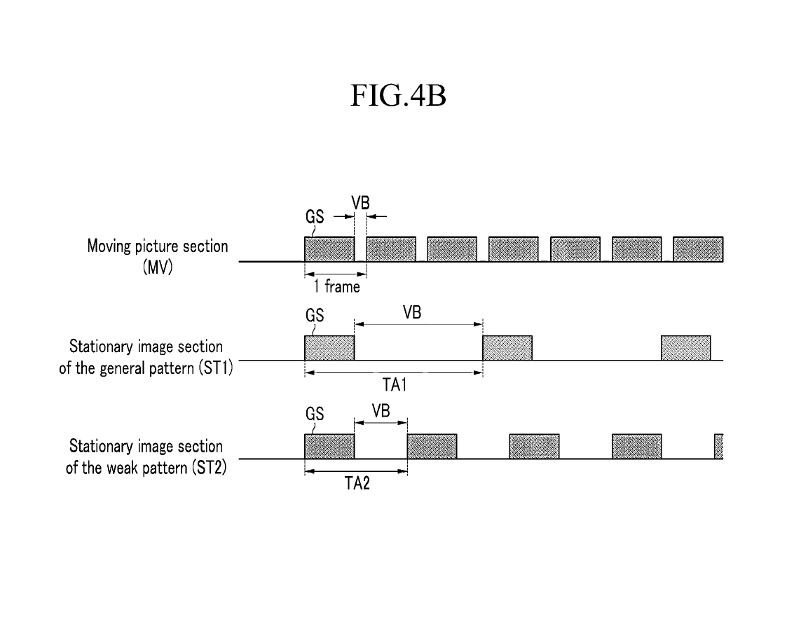

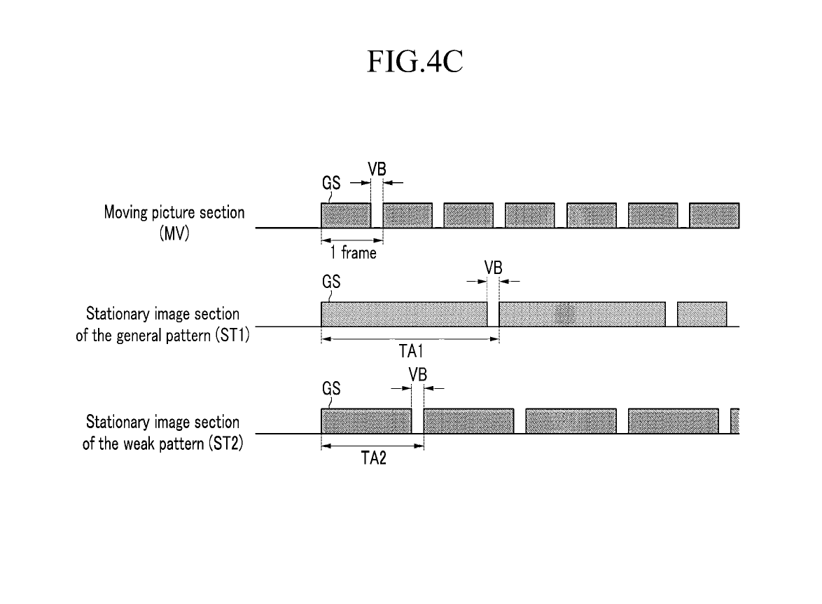

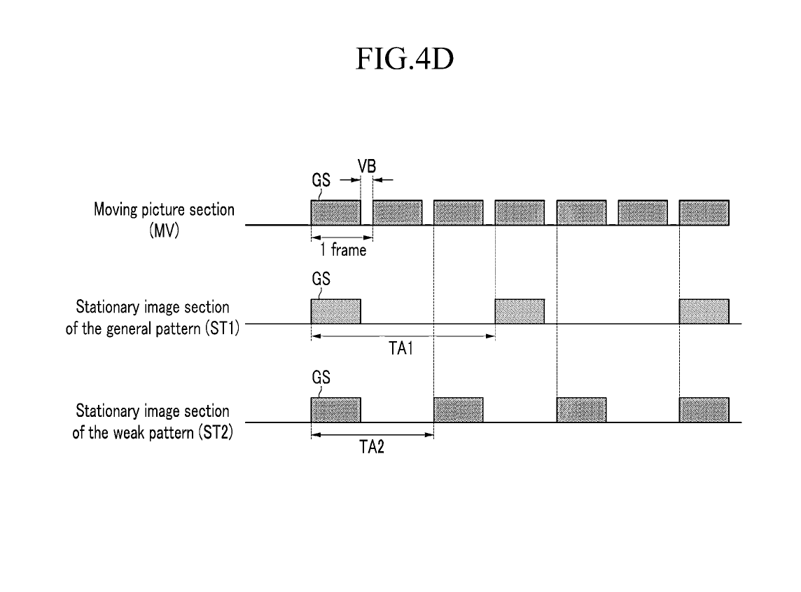

Next, an exemplary driving method of the display device of FIG. 1 will be described with reference to FIGS. 4A and 4B.

FIGS. 4A and 4B are examples of timing diagrams of a driving signal in the display device of FIG. 1.

Referring to FIG. 4A, when an image to be displayed by the display panel 300 includes a motion picture and a stationary image, the image will be displayed in different sections. For example, a motion picture section MV corresponds to the section in which the motion picture is displayed, and a stationary image section corresponds to the section in which the stationary image is displayed. The stationary image section further includes a stationary image section ST1 of the general pattern, and a stationary image section ST2 of the weak pattern.

When the motion picture section MV starts, the graphic processing unit 700 first transfers an input image signal IDAT and an input control signal ICON of the motion picture with a stationary image finish signal to the signal controller 600.

Next, the signal controller 600 generates an image data DAT, a gate control signal CONT1, and a data control signal CONT2, based on the input image signal IDAT and the input control signal ICON. After the image data DAT, the gate control signal CONT1, and the data control signal CONT2 have been generated, the signal controller 600 transfers the gate control signal CONT1 to the gate driver 400, and the image data DAT and the data control signal CONT2 to the data driver 500.

Next, the data driver 500 sequentially latches the image data DAT in each row according to a horizontal synchronizing signal Hsync and a data clock signal, converts the image data DAT into a data voltage, and applies the data voltage to the corresponding data lines D1-Dm.

When a scanning start signal STV is applied to turn-on a switching element connected to the gate lines G1-Gn, the gate driver 400 sequentially applies the gate-on voltages Von to all gate lines G1-Gn, and this corresponds to the gate scanning GS of a frame. Also, the data voltage from the data lines D1-Dm is applied to the corresponding pixel PX via the turned-on switching element.

As described above, the gate scanning GS is performed on all gate lines G1-Gn and the data voltage is applied to all pixels PX, which allow the image of a frame to be displayed. In some embodiments, the polarity of the data voltage may be changed for every frame, the polarity of the data voltage flowing through a data line may be periodically changed (e.g., row inversion or dot inversion), or the polarities of the data voltages applied to a pixel row may be different (e.g., column inversion or dot inversion) depending on the characteristic of an inversion signal RVS in a frame.

In some embodiments, a vertical blank section VB, in which the data voltage and the gate signal are not applied to the display panel 300, may be positioned between adjacent frames. In some other embodiments, a horizontal blank section, in which an input image signal IDAT is not provided, may be positioned between adjacent pixel rows receiving input image signals IDAT.

In some embodiments, the display panel 300 may perform gate scanning GS for every frame in the motion picture section MV, and may display the motion picture using a first frequency. The first frequency may be a frequency at, for example, 60 Hz or 120 Hz. Referring to FIG. 4A, a pulse of the scanning start signal STV indicating the start of scanning of the gate signal may be generated for each frame.

When the stationary image section ST1 of the general pattern or the stationary image section ST2 of the weak pattern starts, the graphic processing unit 700 transfers the input image signal IDAT and the input control signal ICON of the stationary image together with a stationary image start signal to the signal controller 600. As described previously, the stationary image start signal may indicate the start of the stationary image section.

Upon receiving the stationary image start signal, the signal controller 600 recognizes the start of the stationary image section, and stores the input image signal IDAT of the stationary image section in the memory 650. As described previously, the signal controller 600 may deactivate the graphic processing unit 700 during the stationary image section, to prevent the graphic processing unit 700 from transferring the input image signal IDAT of the stationary image section to the signal controller 600 during display of the stationary image section.

The signal controller 600 processes the input image signal IDAT of the stationary image section stored in the memory 650, generates the image data DAT, and transfers the image data DAT to the data driver 500. The display panel 300 may apply the data voltage to all pixels PX to display the image of a frame.

Referring to FIG. 4A, the period of gate scanning GS in the stationary image section ST1 of the general pattern corresponds to the period of the scanning start signal STV, which may be a first period TA1. During the first period TA1, display of the stationary image may be driven using a second frequency that is lower than a first frequency of the motion picture section MV. In some embodiments, the second frequency may not be set lower than a threshold frequency at which flicker is not recognized.

In some embodiments, the display of a stationary image of the general pattern may be driven using a driving frequency that is lower than the driving frequencies for a motion picture, which may reduce power consumption during the display of the stationary image of the general pattern. Additionally, power consumption may be further reduced with the deactivation of the graphic processing unit 700 during the display of the stationary image of the general pattern.

Referring to the stationary image section ST2 of the weak pattern in FIG. 4A, the period of gate scanning GS corresponds to the period of the scanning start signal STV, which may be a second period TA2. As shown in FIG. 4A, the second period TA2 is shorter than the first period TA1. During the second period TA2, the display of the stationary image of the weak pattern is driven using a third frequency that is higher than the second frequency of the stationary image section ST1 of the general pattern. The third frequency may be a driving frequency that is selected by the frequency selection portion 620 of the signal controller 600. In some embodiments, the third frequency may be equal to or less than the first frequency.

When the stationary image of the weak pattern is displayed using the second frequency associated with the stationary image of the general pattern, display defects such as flickers and vertical line defects may occur. The display defects may be reduced by setting the driving frequency of the stationary image of the weak pattern to be higher than the driving frequency of the stationary image of the general pattern. The display defects may also be reduced if the driving frequency of the stationary image of the weak pattern is increased to at least the level of the driving frequency of a motion picture.

Next, exemplary methods implementing the second frequency and the third frequency as the respective driving frequency in the stationary image section ST1 of the general pattern and the stationary image section ST2 of the weak pattern will be described with reference to FIGS. 4B, 4C, and 4D.

Referring to FIG. 4B, the length of the gate scanning GS section in the stationary image section ST1 of the general pattern and the length of the gate scanning GS section in the stationary image section ST2 of the weak pattern may each be the same as the length of the gate scanning GS section in the motion picture section MV. However, the length of the vertical blank section VB in the stationary image section ST1 of the general pattern, the length of the vertical blank section VB in the stationary image section ST2 of the weak pattern, and the length of the vertical blank section VB in the motion picture section MV may be different. For example, as shown in FIG. 4B, the length of the vertical blank section VB in the stationary image section ST2 of the weak pattern is shorter than the length of the vertical blank section VB in the stationary image section ST1 of the general pattern, and the length of the vertical blank section VB in the stationary image section ST2 of the weak pattern is greater than the length of the vertical blank section VB in the motion picture section MV. In some embodiments, the length of the vertical blank section VB in the stationary image section ST2 of the weak pattern is the same as the length of the vertical blank section VB in the motion picture section MV. The driving frequency for each of the sections shown in FIG. 4B may be adjusted by adjusting the length of the vertical blank section VB.

Next, referring to FIG. 4C, the length of the vertical blank section VB in the stationary image section ST1 of the general pattern and the length of the vertical blank VB in the stationary image section ST2 of the weak pattern may each be approximately the same as the length of the vertical blank VB section in the motion picture section MV. However, the length of the gate scanning GS section in the stationary image section ST1 of the general pattern, the length of the gate scanning GS section in the stationary image section ST2 of the weak pattern, and the length of the gate scanning GS section in the motion picture section MV may be different. For example, as shown in FIG. 4C, the length of the gate scanning GS section in the stationary image section ST2 of the weak pattern is shorter than the length of the gate scanning GS section in the stationary image section ST1 of the general pattern, and the length of the gate scanning GS section in the stationary image section ST2 of the weak pattern is greater than the length of the gate scanning GS section in the motion picture section MV. In some embodiments, the length of the gate scanning GS section in the stationary image section ST2 of the weak pattern may be the same as the length of the gate scanning GS section in the motion picture section MV. The driving frequency of each section may be adjusted by adjusting the length of the gate scanning GS section. In some embodiments, the length of the gate scanning GS section of a frame may be adjusted by adjusting the length of a horizontal blank section or by adjusting the period of a data clock signal.

Referring to FIG. 4D, the first period TA1 of the stationary image section ST1 of the general pattern and the second period TA2 of the stationary image section ST2 of the weak pattern may each be a multiple of a frame, and this may be implemented by adjusting the frequency obtained from the input image signal IDAT stored in the memory 650.

As previously described with reference to FIGS. 4B and 4C, the second frequency and the third frequency may be implemented as the respective driving frequency in the stationary image section ST1 of the general pattern and the stationary image section ST2 of the weak pattern using various methods. In some embodiments, the driving frequency may be controlled by adjusting one or more factors such as the length of a vertical blank section VB, the length of a horizontal blank section, or the period of a data clock signal.

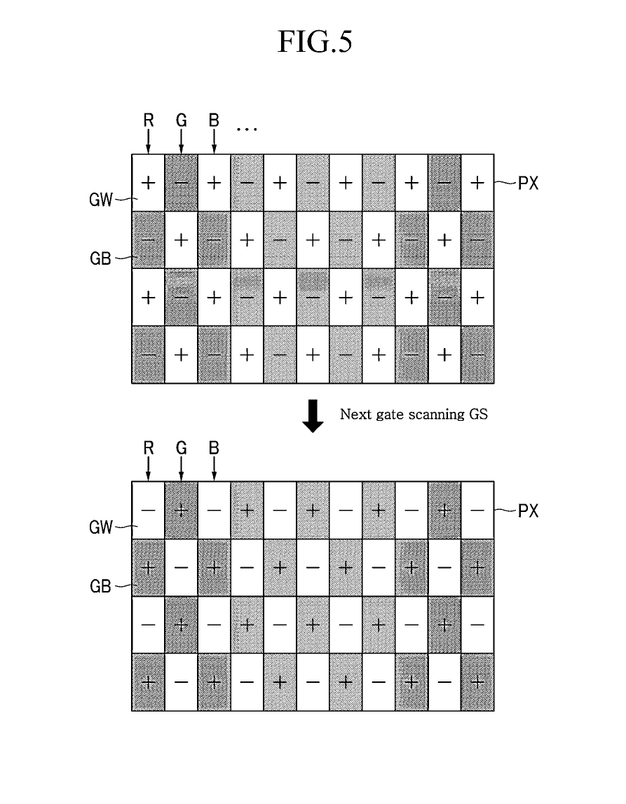

Next, different examples of the weak pattern stored in the memory 650 of the display device of FIG. 1 will be described with reference to FIGS. 5 to 8.

FIGS. 5 to 8 illustrate examples of stationary image weak patterns displayed by the display device according to different embodiments of the present invention.

As described previously, a plurality of pixels PX included in the display device may be arranged in a matrix form. The pixels PX in each pixel row or each pixel column may display the same primary color. As shown in FIGS. 5 to 8, each pixel PX displays a color from one of primary colors red R, green G, and blue B, with the pixels PX in each pixel column displaying the same color, and pixel columns displaying red R, green G, and blue B alternately disposed.

Referring to FIG. 5, the display device may be driven by 1×1 dot inversion driving, which is inversion driving of a horizontal pixel and a vertical pixel. FIG. 5 shows an example of a weak pattern as a result of 1×1 dot inversion driving. As shown in the top pattern of FIG. 5, all pixels PX where the polarity of the data voltage to a frame is negative (−) display a black gray, and all pixels PX where the polarity of the data voltage is positive (+) display a white gray. The black gray and the white gray may be alternately displayed in a row direction and a column direction. In some embodiments, the polarities of data voltages corresponding to the white gray and the black gray may be switched.

In the example of FIG. 5, if a pixel PX displays the same gray (which may be white gray or black gray) over a long period of time, the overall polarity of the pixel PX may bias towards a certain polarity, which may result in image quality defects such as flickers during the next gate scanning GS. However, as described previously, image quality defects from the weak pattern may be reduced by driving the display device to a high frequency. As shown in the bottom pattern of FIG. 5, the polarities of the data voltages of all pixels PX may be switched after the next gate scanning GS.

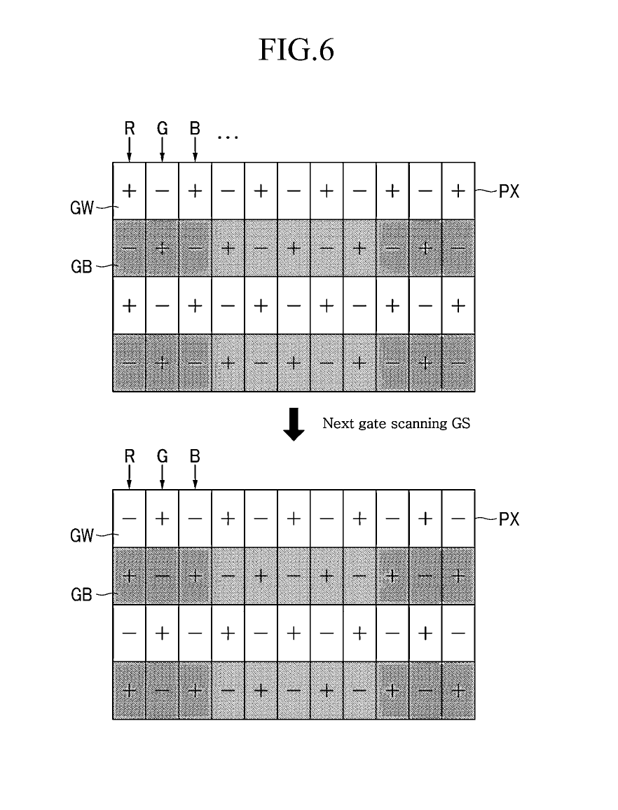

FIG. 6 shows another example of a weak pattern as a result of 1×1 dot inversion driving. As shown in the top pattern of FIG. 6, the pixels PX in alternate pixel rows of a frame may display the same gray, and the pixels PX in adjacent pixel rows may display different grays. The pixel row displaying the black gray and the pixel row displaying the white gray may also be alternately disposed in a column direction. In some embodiments, a plurality of adjacent pixel rows may constitute a block, with the block displaying the same gray and adjacent blocks displaying different grays.

As shown in the top pattern of FIG. 6, the polarities of the pixels PX displaying the white gray are the same for the pixels PX disposed in each pixel column. If each pixel PX displays the same gray (which may be white gray or black gray) over a long period of time, the polarities of the pixels PX disposed in each pixel column may bias towards a certain polarity, which may result in image quality defects such as flickers during the next gate scanning GS. However, as described previously, image quality defects from the weak pattern may be reduced by driving the display device to a high frequency. As shown in the bottom pattern of FIG. 6, the polarities of the data voltages of all pixels PX may be switched after the next gate scanning GS.

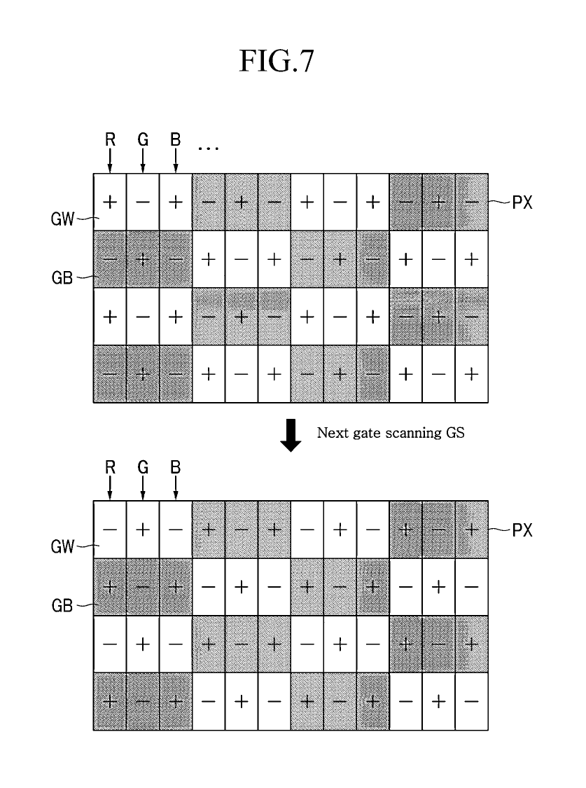

FIG. 7 shows another example of a weak pattern as a result of 1×1 dot inversion driving. When a red R pixel, a green G pixel, and a blue B pixel adjacent to each other are set as a dot, the dot may display the same gray. Dots adjacent to each other in a row direction and column direction may display different grays. As shown in the top pattern of FIG. 7, a dot displaying the same gray has two pixels PX with the same polarity, and a residual pixel PX with a different polarity. As a result, the overall polarity of the dot displaying the same gray may bias towards the polarity of the two pixels PX having the same polarity. In some embodiments, a plurality of dots may constitute a block, with the block displaying the same gray and adjacent blocks displaying different grays.

In the example of FIG. 7, if a dot displays the same gray (white gray or the black gray) over a long period of time, the overall polarity of the dot may bias towards a certain polarity, which may result in image quality defects such as flickers during the next gate scanning GS. However, as described previously, image quality defects from the weak pattern may be reduced by driving the display device to a high frequency. As shown in the bottom pattern of FIG. 7, the polarities of the data voltages of all pixels PX may be switched after the next gate scanning GS.

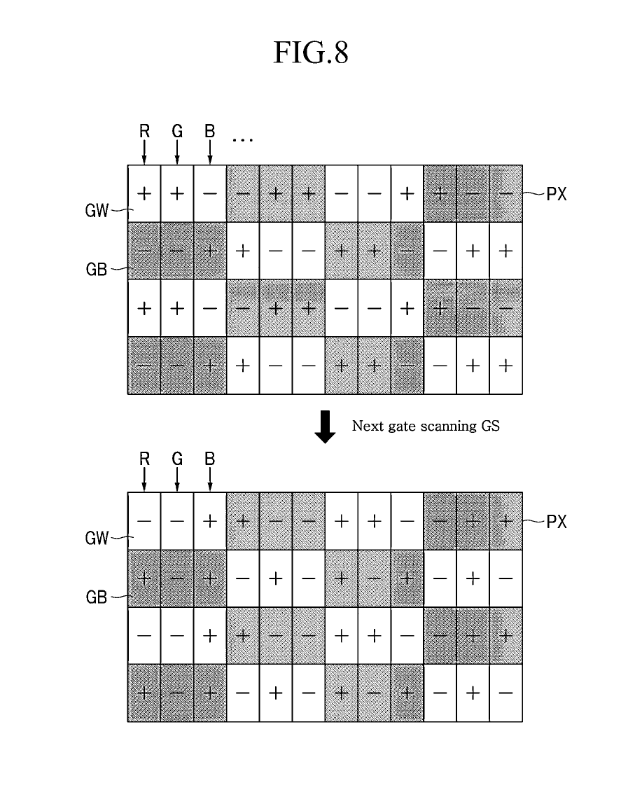

Referring to FIG. 8, the display device may be driven by 2×1 dot inversion driving, which is inversion driving of two horizontal pixels and one vertical pixel. FIG. 8 shows an example of a weak pattern as a result of 2×1 dot inversion driving. When a red R pixel, a green G pixel, and a blue B pixel adjacent to each other are set as a dot, the dot may display the same gray. Dots adjacent to each other in a row direction and a column direction may display different grays. As shown in the top pattern of FIG. 8, a dot displaying the same gray has two pixels PX with the same polarity, and a residual one pixel PX with a different polarity. As a result, the overall polarity of the dot displaying the same gray may bias towards to the polarity of the two pixels PX having the same polarity. In some embodiments, a plurality of dots may constitute a block, with the block displaying the same gray and adjacent blocks displaying different grays.

In the example of FIG. 8, if a dot displays the same gray (white gray or the black gray) over a long period of time, the overall polarity of the dot may bias towards a certain polarity, which may result in image quality defects such as flickers during the next gate scanning GS. However, as described previously, image quality defects from the weak pattern may be reduced by driving the display device to a high frequency. As shown in the bottom pattern of FIG. 8, the polarities of the data voltages of all pixels PX may be switched after the next gate scanning GS.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A driving method of a display device, the display device comprising a display panel having a plurality of pixels, a signal controller for controlling operation of the display panel, and a memory connected to the signal controller, the method comprising:
receiving an input image signal for a motion picture or a stationary image, and
if the input image signal for the stationary image is received:
determining whether the stationary image includes at least one weak pattern;
setting a first frequency as a driving frequency to display the stationary image if the stationary image does not include a weak pattern; and
setting a second frequency that is higher than the first frequency as the driving frequency if the stationary image includes the at least one weak pattern.

2. The driving method of claim 1, wherein the memory stores information on the at least one weak pattern.

3. The driving method of claim 2, wherein:
the information on the at least one weak pattern includes information on a frequency corresponding to the at least one weak pattern, and
the frequency corresponding to the at least one weak pattern is higher than the first frequency.

4. The driving method of claim 3, wherein:
the at least one weak pattern includes a first weak pattern and a second weak pattern that is different from the first weak pattern, and
determining whether the stationary image includes at least one weak pattern comprises determining whether the stationary image includes the first weak pattern and the second weak pattern.

5. The driving method of claim 4, wherein after determining the stationary image includes the first weak pattern and the second weak pattern:
selecting either a frequency corresponding to the first weak pattern or a frequency corresponding to the second weak pattern as the second frequency.

6. The driving method of claim 5, wherein the at least one weak pattern depends on an inversion driving mode of the display panel.

7. The driving method of claim 6, wherein:
the information on the at least one weak pattern includes gray information of the plurality of pixels,
the gray information includes a first gray and a second gray that is different from the first gray, and
the information on the at least one weak pattern includes information on a gray difference between the first gray and the second gray.

8. The driving method of claim 7, wherein the information on the at least one weak pattern includes information on a size of the at least one weak pattern.

9. The driving method of claim 8, further comprising:
setting a third frequency that is higher than the first frequency as the driving frequency.

10. The driving method of claim 9, wherein the second frequency is equal to or less than the third frequency.

11. A display device comprising:
a display panel having a plurality of pixels for displaying an image at a driving frequency;
a signal controller configured to: receive an input image signal for a motion picture or a stationary image, determine whether the stationary image includes at least one weak pattern if the input image signal for the stationary image is received, and control operation of the display panel; and
a memory connected to the signal controller, the memory configured to store information on the at least one weak pattern;
wherein the display panel is configured to:
display the stationary image by setting a first frequency as the driving frequency if the stationary image does not include any weak pattern, and
display the stationary image by setting a second frequency that is higher than the first frequency as the driving frequency if the stationary image includes the at least one weak pattern.

12. The display device of claim 11, wherein the signal controller includes:
a pattern recognition portion configured to determine whether the stationary image includes the at least one weak pattern based on the input image signal, and
a frequency selection portion configured to determine the driving frequency based on a determination result received from the pattern recognition portion.

13. The display device of claim 12, wherein the information on the at least one weak pattern includes:
information on a frequency corresponding to the at least one weak pattern, and the frequency corresponding to the at least one weak pattern is higher than the first frequency.

14. The display device of claim 13, wherein:
the at least one weak pattern includes a first weak pattern and a second weak pattern that is different from the first weak pattern, and
the pattern recognition portion includes a first pattern recognition portion configured to determine whether the stationary image includes the first weak pattern and a second pattern recognition portion configured to determine whether the stationary image includes the second weak pattern.

15. The display device of claim 14, wherein after the first pattern recognition portion has determined that the stationary image includes the first weak pattern and the second pattern recognition portion has determined that the stationary image includes the second weak pattern,
the frequency selection portion selects either a frequency corresponding to the first weak pattern or a frequency corresponding to the second weak pattern as the second frequency.

16. The display device of claim 15, wherein the at least one weak pattern depends on an inversion driving mode of the display panel.

17. The display device of claim 16, wherein:
the information on the at least one weak pattern includes gray information of the plurality of pixels,
the gray information includes a first gray and a second gray that is different from the first gray, and
the information on the at least one weak pattern includes information on a gray difference between the first gray and the second gray.

18. The display device of claim 17, wherein the information on the at least one weak pattern includes information on a size of the at least one weak pattern.

19. The display device of claim 18, wherein:
the motion picture is displayed by setting a third frequency that is higher than the first frequency as the driving frequency, and
the second frequency is equal to or less than the third frequency.
